(19) United States
(12) Patent Application Publication
(10) Pub. No.: US 2011/0143802 A1
(43) Pub. Date: Jun. 16, 2011

(54) PAGING MANAGEMENT METHOD AND SYSTEM FOR HOME EVOLVED BASE STATION

(75) Inventors: Jae Sheung SHIN, Daejeon (KR); Sung Gu CHOI, Daejeon (KR); Changki KIM, Daejeon (KR); Soon Gi PARK, Daejeon (KR); Yeon Seung SHIN, Daejeon (KR)

(73) Assignee: Electronics and Telecommunications Research Institute, Daejeon (KR)

(21) Appl. No.: 12/873,804

(22) Filed: Sep. 1, 2010

(30) Foreign Application Priority Data
Dec. 15, 2009 (KR) 10-2009-0124499

(51) Int. Cl. H04W 84/02

(52) U.S. Cl. 455/515

(57) ABSTRACT

Provided is a paging management system that may transfer a paging message to only a small base station where a terminal is estimated to be positioned, and thereby decrease a traffic amount required to transfer the paging message. A paging management method may include: configuring a virtual tracking area by grouping a plurality of small base stations according to a position of a small base station accessed by a terminal; verifying a final small base station accessed by the terminal when a paging message is to be transmitted to the terminal; and transferring the paging message to small base stations of the virtual tracking area including the final small base station.

### CROSS-REFERENCE TO RELATED APPLICATION

This application claims the benefit of Korean Patent Application No. 10-2009-0124499, filed on Dec. 15, 2009, in the Korean Intellectual Property Office, the disclosure of which is incorporated herein by reference.

### BACKGROUND

1. Field of the Invention

The present invention relates to a paging management method and system of a mobile communication system, and more particularly, to a paging management method and system that may transfer a paging message to only a small base station where a terminal is estimated to be positioned, and thereby decrease a traffic amount required to transfer the paging message.

2. Description of the Related Art

As one factor of a next generation mobile communication system, a miniature home evolved base station, for example, a Home evolved Node-B (HeNB) that may be directly installed and operated at home by a user is developed.

In a mobile communication system, the miniature home evolved base station may relay transmission and reception of information between a terminal and a Mobile Management Entity (MME) or a serving gateway (S-GW).

Many miniature base stations may be connected to a single MME and an S-GW. In this case, to prevent load from increasing due to connection settings and data transfer, a miniature home evolved base station gateway connected to a predetermined number of miniature home evolved base stations may be connected to the MME and the S-GW in representation of the miniature home evolved base stations.

But, There is no particular setting on separate area management for the CSG cells.

Accordingly, when a paging message is transmitted to a CSG cell, the MME may transfer the paging message to all the base stations belonging to a tracking area where the terminal is registered, a corresponding miniature home evolved base station, and a corresponding miniature home evolved base station gateway.

Also, the miniature home evolved base station gateway may relay again the paging message to its all the miniature base stations.

When a plurality of macro cells belongs to a single tracking area and many CSG cells are overlapped with the macro cells, a transfer amount of paging messages may be duplicate and significantly increase. Accordingly, excessive paging traffic may occur.

Accordingly, there is a desire for a paging management method that may prevent the excessive paging traffic.

### SUMMARY

An aspect of the present invention provides a paging management method and system that may transfer a paging message to only a small base station included in a virtual tracking area where a terminal is positioned, and thereby may significantly decrease paging traffic, instead of grouping small base stations into a corresponding virtual tracking area according to a position of a corresponding small base station, and transferring the paging message to all the small base stations included in the virtual tracking area.

Another aspect of the present invention also provides a paging management method and system that may transmit, to each of small base stations, a list of small base stations grouped into a virtual tracking area, and may broadcast the list to terminals positioned within an area of a corresponding small base station to update in real time a virtual tracking area including the terminals, and thereby may easily verify the virtual tracking area.

According to an aspect of the present invention, there is provided a paging management system, including: a small base station gateway to configure a virtual tracking area by grouping a plurality of small base stations according to a position of a small base station accessed by a terminal, to verify a final small base station accessed by the terminal when a paging message is to be transmitted to the terminal, and to transfer the paging message to small base stations of the virtual tracking area including the final small base station.

According to another aspect of the present invention, there is provided a paging management method, including: configuring a virtual tracking area by grouping a plurality of small base stations according to a position of a small base station accessed by a terminal; verifying a final small base station accessed by the terminal when a paging message is to be transmitted to the terminal; and transferring the paging message to small base stations of the virtual tracking area including the final small base station.

### EFFECT

According to embodiments of the present invention, it is possible to significantly decrease paging traffic by transferring a paging message to only a small base station included in a virtual tracking area where a terminal is positioned, instead of grouping small base stations into a corresponding virtual tracking area according to a position of a corresponding small base station, and transferring the paging message to all the small base stations included in the virtual tracking area.

Also, according to embodiments of the present invention, it is possible to easily verify the virtual tracking area of the terminal by transmitting, to each of small base stations, a list of small base stations grouped into a virtual tracking area, and by broadcasting the list to terminals positioned within an area of a corresponding small base station to update in real time a virtual tracking area including the terminals.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an example of a paging management system according to an embodiment of the present invention;

FIG. 2 is a flowchart illustrating a paging management method according to an embodiment of the present invention;

FIG. 3 is a diagram illustrating an example of configuring a virtual tracking area according to an embodiment of the present invention;

FIG. 4 is a diagram illustrating another example of configuring a virtual tracking area according to an embodiment of the present invention;

FIG. 5 is a diagram illustrating an example of reconfiguring a virtual tracking area according to an embodiment of the present invention;

FIG. 6 is a flowchart illustrating a process of transferring a paging message of FIG. 2;

FIG. 7 is a flowchart illustrating a method of operating a small base station in a paging management system according to an embodiment of the present invention; and

FIG. 8 is a flowchart illustrating a method of operating a terminal in a paging management system according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

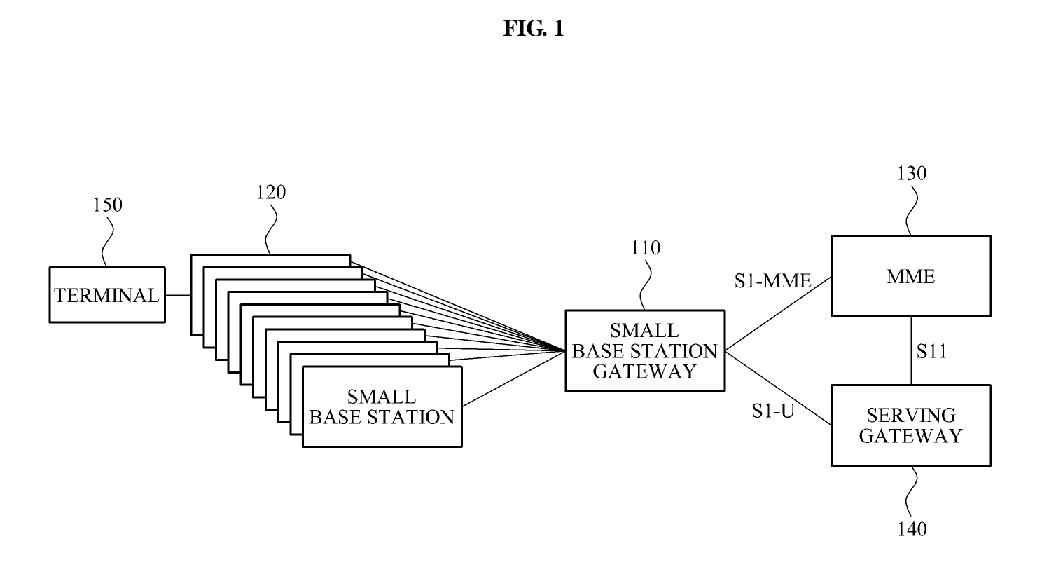

FIG. 1 is a diagram illustrating an example of a paging management system according to an embodiment of the present invention.

Referring to FIG. 1, the paging management system may include a small base station gateway 110, a plurality of small base stations including a small base station 120 connected by a terminal 150, a Mobility Management Entity (MME) 130, and a serving gateway 140.

The small base station gateway 110 may be connected to the plurality of small base stations, and may relay communications between the small base stations and the MME 130 or the serving gateway 140. In this instance, the small base station gateway 110 may configure a virtual tracking area by grouping the plurality of small base stations according to a position of the small base station 120 accessed by the terminal 150, may verify a final small base station accessed by the terminal 150 when a paging message is to be transmitted to the terminal 150, and may transfer the paging message to small base stations of the virtual tracking area including the final small base station.

The small base station gateway 110 may configure, for each of the small base stations, the virtual tracking area by grouping a plurality of small base stations positioned within a predetermined distance from each corresponding small base station. In this instance, the small base station gateway 110 may identify the small base stations positioned with the predetermined distance, based on a list of small base stations stored when the corresponding small base stations are registered.

As one example, when the accessed small base station 120 includes a positioning equipment, the small base station gateway 110 may receive, from the accessed small base station 120, position information of the accessed small base station 120 measured by the positioning equipment to verify a position of the accessed small base station 120.

The small base station gateway 110 may set a circle having a radius of the predetermined distance based on the accessed small base station 120 using the position information, and may configure the virtual tracking area by grouping a plurality of small base stations included within the circle.

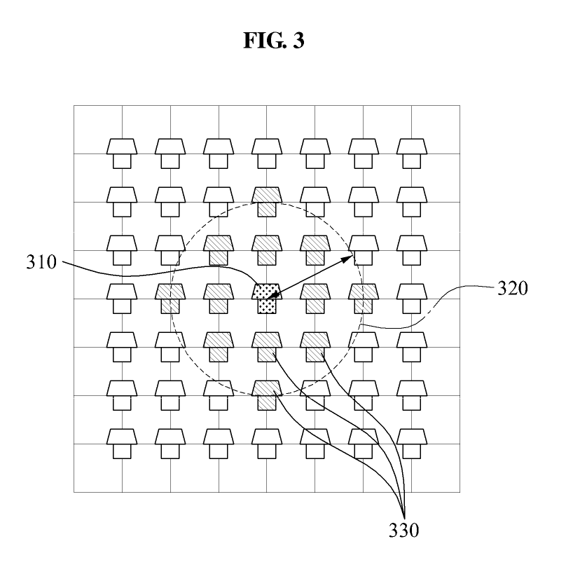

The above example will be further described with reference to FIG. 3.

As another example, when the accessed small base station 120 does not include a positioning equipment, the small base station gateway 110 may receive, from the accessed small base station 120, information associated with a neighboring small base station of the accessed small base station 120, and may calculate a position of the accessed small base station 120 based on a position of the neighboring small base station.

The small base station gateway 110 may group a plurality of small base stations positioned within a predetermined number of hops from the accessed small base station 120, and thereby may configure the virtual tracking area.

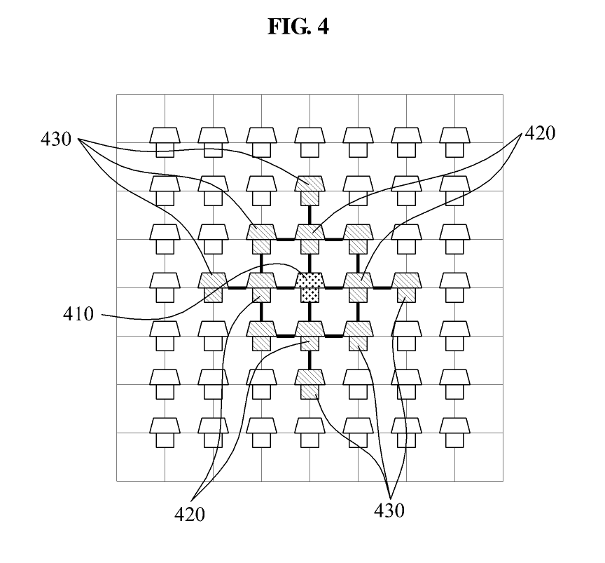

The other example will be further described with reference to FIG. 4.

Also, when a predetermined small base station is added or deleted, the small base station gateway 110 may reconfigure the virtual tracking area according to the added or deleted small base station.

The small base station gateway 110 may select, as a representative base station, one of small base stations included in the virtual tracking area. When reconfiguring the virtual tracking area, the small base station gateway 110 may reconfigure the virtual tracking area based on the representative base station.

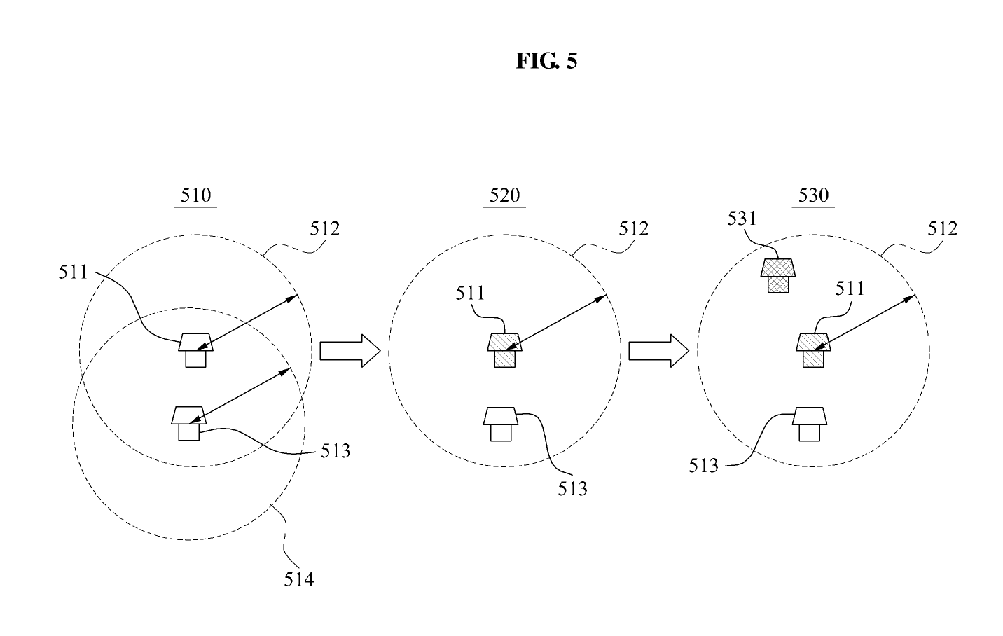

The process of reconfiguring the virtual tracking area will be further described with reference to FIG. 5.

When the virtual tracking area is completely configured and the list of small base stations included in the virtual tracking area is completed, the small base station gateway 110 may transfer the list to each of the small base stations included in the virtual tracking area to each of the small base stations included in the virtual tracking area.

In this instance, the accessed small base station 120 may broadcast the transferred list to terminals positioned within an area of the accessed small base station 120.

The small base station gateway 110 may transfer the paging message to small base stations accessible by the terminal 150 among the plurality of small base station of the virtual tracking area including the final small base station.

Specifically, when the small base station gateway 110 receives the paging message from the MME 130, the small base station gateway 110 ma verify the final small base station in which a state of a terminal to receive the paging message is shifted to an idle state, based on a terminal identifier (ID) included in the paging message, and then search for the list of small base stations included in the virtual tracking area including the final small base station.

Next, the small base station gateway 110 may transfer the paging message to only small base stations accessible by the terminal 150 among the small base stations included in the list.

In this instance, a small base station accessible by the terminal 150 may be a public small base station of which a CSG cell allows accesses of all the terminals, or may be a private small base station of which a CSG cell allows an access of the terminal to receive the paging message. In this instance, among small base stations satisfying the above condition, a small base station providing a service to a maximum possible number of terminals may be excluded from the small base stations accessible by the terminal 150.

When paging fails and thereby is reattempted, the small base station gateway 110 may readjust the virtual tracking area so that a paging success probability may increase, and then retransmit the paging message to small base stations included in the readjusted virtual tracking area.

In this instance, the small base station gateway 110 may readjust the virtual tracking area by increasing a radius of the virtual tracking area, or by increasing a number of hops included in the virtual tracking area.

The small base station 120 may be a miniature home evolved small base station, for example, a Home evolved Node-B (HeNB) that may be directly installed and operated at home by a user.

The small base station 120 may cover a region within tens of meters based on a low transmission power and thus may be a low capacity of a base station available within home or a building, and accommodate a small number of users, for example, around 10 users. A cell managed by a single small base station is referred to as a CSG cell. A unique ID, for example, a CSG ID may be allocated to the single CSG cell.

In an initial installation, the small base station 120 may receive information associated with small base station gateways operated in a network according to an operation maintenance function of the network.

When a plurality of small base station gateways is operated, the small base station 120 may select one of the small base station gateways. When the small base station gateway 110 is selected, the small base station may be registered in the selected small base station gateway 110 according to an MME selection and registration procedure defined in an existing third Partnership Project (3GPP) standard.

The small base station 120 including a positioning equipment such as a Global Positioning System (GPS) may measure its position using the positioning equipment, and may transfer information associated with the measured position to the small base station gateway 110.

The small base station 120 not including the positioning equipment may transfer information associated with a neighboring base station to the small base station gateway 110, based on system information received from the neighboring base station.

The small base station gateway 110 may store and manage position information of the small base station 120 and the neighboring small base station together with the list.

The MME 130 may be connected to the small base station gateway 110 via an S1-MME interface, and may be connected to the serving gateway 140 via an S11 interface.

Also, the serving gateway 140 may be connected to the small base station gateway 110 via an S1-U interface.

The terminal 150 may store the list of small base stations included in the virtual tracking area, in system information broadcast from the small base station 120. When the terminal 150 enters an area of a small base station excluded from the list, the terminal 150 may update information associated with a new virtual tracking area.

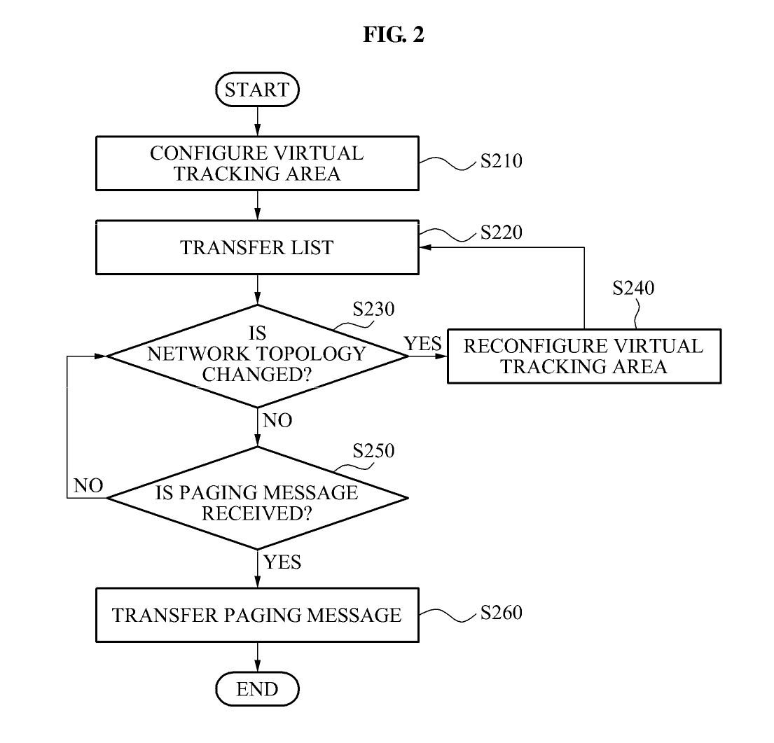

FIG. 2 is a flowchart illustrating a paging management method according to an embodiment of the present invention.

In operation S210, a small base station gateway may configure a virtual tracking area by grouping a plurality of small base stations according to a position of a small base station accessed by a terminal.

Specifically, the small base station gateway may configure, for each small base station, the virtual tracking area by grouping the plurality of small base stations within a predetermined distance from each corresponding small base station, based on position information transmitted from the accessed small base station or information associated with a neighboring small base station of the accessed small base station.

In operation S220, the small base station gateway may transfer a list of small base stations included in the virtual tracking area to each of the small base stations included in the virtual tracking area.

In operation S230, the small base station gateway may verify whether a network topology is changed.

Specifically, the small base station gateway may detect whether a predetermined small base station is added or deleted and thereby a network configuration is changed.

When the predetermined small base station is added or deleted, the small base station gateway may reconfigure the virtual tracking area according to the added or deleted small base station in operation S240, and then go to operation S220 to transfer the list.

In operation S250, the small base station gateway may verify whether a paging message is received from an MME.

When the paging message is received from the MME, the small base station gateway may transfer the paging message to each of the small base stations of the virtual tracking area according to the received paging message in operation S260.

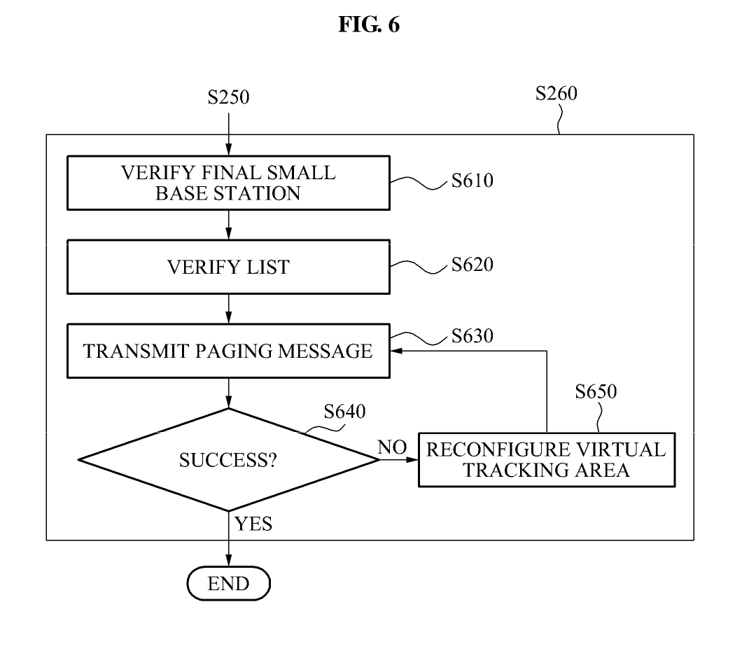

Operation S260 of transferring the paging message will be further described with reference to FIG. 6.

FIG. 3 is a diagram illustrating an example of configuring a virtual tracking area according to an embodiment of the present invention.

FIG. 3 illustrates a process of configuring, by a small base station gateway, the virtual tracking area when a small base station 310 includes a positioning equipment.

When position information of the small base station 310 measured by the positioning equipment is received, the small base station gateway may set a circle 320 having a radius of a predetermined distance based on the small base station 310 using position information, and may configure the virtual tracking area including small base stations 330 positioned within the circle.

The small base station gateway may store and manage a list of small base stations included in the virtual tracking area together with the small base station 310.

FIG. 4 is a diagram illustrating another example of configuring a virtual tracking area according to an embodiment of the present invention.

FIG. 4 illustrates a process of configuring, by a small base station gateway, the virtual tracking area when a small base station 410 does not include a positioning equipment.

When the small base station gateway receives area information of neighboring small base stations 420 of the small base station 410, the small base station gateway may configure the virtual tracking area by grouping small base stations positioned within a predetermined number of hops from the small base station 410.

For example, when the predetermined number of hops is set to “2”, the small base station gateway may configure the virtual tracking area including the small base stations 420 and other small base stations 430 adjacent to the small base stations 420 by grouping the small base stations 420 corresponding to hop 1, and the small base stations 430 corresponding to hop 2.

FIG. 5 is a diagram illustrating an example of reconfiguring a virtual tracking area according to an embodiment of the present invention.

FIG. 5 illustrates an example of reconfiguring, by a small base station gateway, the virtual tracking area when a small base station (HeNB-2) 531 is added.

When a small base station 513 including another virtual tracking area 514 exists within a virtual tracking area (HeNB-2) 512 of a small base station (HeNB-1) 511 as shown in a left diagram 510, the small base station gateway may select the small base station (HeNB-1) 511 as a representative base station as shown in a middle diagram 520.

When the small base station (HeNB-3) 531 is added and thereby a virtual tracking area 532 is reconfigured as shown in a right diagram 530, the small base station gateway may reconfigure the virtual tracking area 532 based on the small base station (HeNB-1) 511 selected as the representative base station.

FIG. 6 is a flowchart illustrating operation S260 of transferring a paging message of FIG. 2. Operations 5610 through 5650 may be included in operation S260 of FIG. 2.

In operation S610, the small base station gateway may verify a final small base station accessed by the terminal.

Specifically, when the small base station gateway receives the paging message in operation S250, the small base station gateway may verify the final small base station in which a state of a terminal to receive the paging message is shifted to an idle state, based on a terminal ID included in the paging message.

In operation S620, the small base station gateway 110 may verify a list of small base stations included in the virtual tracking area of the verified final small base station.

In operation S630, the small base station gateway 110 may transfer the paging message to only small base stations accessible by the terminal among the small base stations included in the list.

In this instance, a small base station accessible by the terminal may be a public small base station of which a CSG cell allows accesses of all the terminals, or may be a private small base station of which a CSG cell an access of a terminal to receive the paging message. In this instance, among small base stations satisfying the above condition, a small base station providing a service to a maximum possible number of terminals may be excluded from the small base stations accessible by the terminal.

In operation S640, the small base station gateway may verify whether the transmission of the paging message is a success or a failure and thereby paging needs to be reattempted.

When the transmission of the paging message fails, the small base station gateway may readjust the virtual tracking area so that a paging success probability may increase, and then retransmit the paging message to small base stations included in the readjusted virtual tracking area in operation S650.

In this instance, the small base station gateway may readjust the virtual tracking area by increasing a radius of the virtual tracking area, or by increasing a number of hops included in the virtual tracking area.

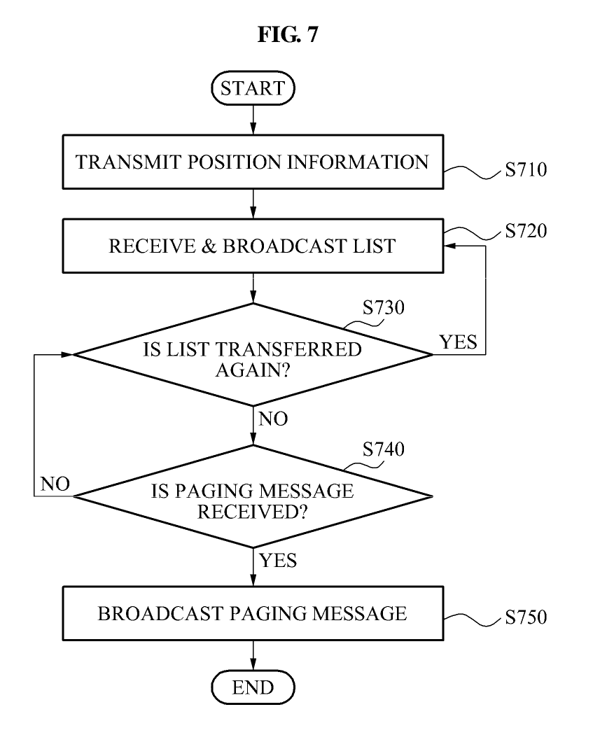

FIG. 7 is a flowchart illustrating a method of operating a small base station in a paging management system according to an embodiment of the present invention.

In operation S710, when the small base station is positioned within an area of a small base station gateway, the small base station may transmit position information to the small base station gateway.

Specifically, the small base station including a positioning equipment such as a GPS may measure its position using the positioning equipment, and may transfer information associated with the measured position to the small base station gateway.

The small base station not including the positioning equipment may transfer information associated with a neighboring base station to the small base station gateway, based on system information received from the neighboring base station.

The small base station gateway 110 may store and manage position information of the small base station and the neighboring small base station together with the list.

In this instance, the small base station gateway may configure a virtual tracking area based on the transferred position information.

In operation S720, the small base station may broadcast a list of small base station included in the virtual tracking area, transferred in the small base station gateway 110, to terminals positioned within the area of the small base station, based on system information.

In operation S730, the small base station may verify whether the list of small base stations included in the virtual tracking area is transferred again.

When the list is transferred again, the small base station may go to operation S720 and broadcast the transferred list.

Conversely, when the list is not transferred again, the small base station may verify whether a paging message is received in operation S740.

In operation S750, the small base station may broadcast the transferred paging message to terminals positioned in the area of the small base station.

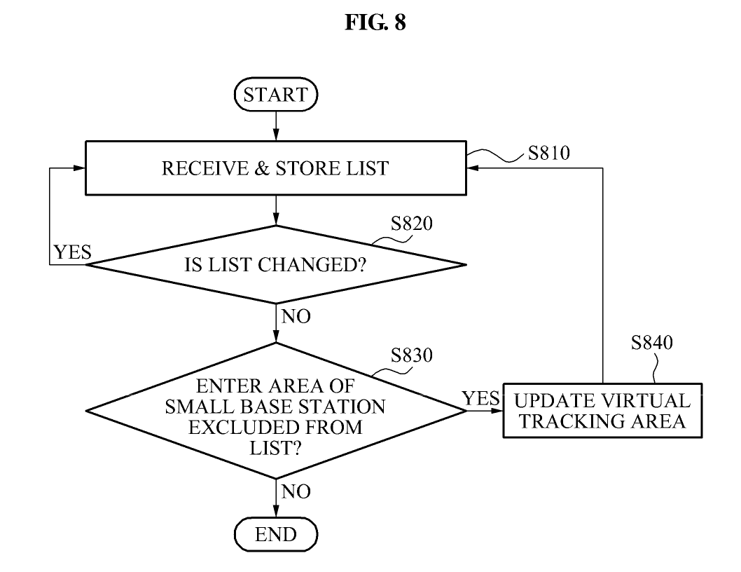

FIG. 8 is a flowchart illustrating a method of operating a terminal in a paging management system according to an embodiment of the present invention.

In operation S810, the terminal may extract, from system information, a list of small base stations included in a virtual tracking area and store the extracted list.

In operation S820, the terminal may verify whether the list is changed.

When the list is changed, the terminal may go to operation S810 and store the changed list.

In operation S830, the terminal may verify whether the terminal enters an area of a small base station excluded from the list.

In operation S840, the terminal may update information associated with a new virtual tracking area including the entered small base station.

According to embodiments of the present invention, a paging managing system may significantly decrease paging traffic by transferring a paging message to only a small base station included in a virtual tracking area where a terminal is positioned, instead of grouping small base stations into a corresponding virtual tracking area according to a position of a corresponding small base station, and transferring the paging message to all the small base stations included in the virtual tracking area.

Also, according to embodiments of the present invention, a paging managing system may easily verify the virtual tracking area of the terminal by transmitting, to each of small base stations, a list of small base stations grouped into a virtual tracking area, and by broadcasting the list to terminals positioned within an area of a corresponding small base station to update in real time a virtual tracking area including the terminals.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A paging management system, comprising:
a small base station gateway to configure a virtual tracking area by grouping a plurality of small base stations according to a position of a small base station accessed by a terminal, to verify a final small base station accessed by the terminal when a paging message is to be transmitted to the terminal, and to transfer the paging message to small base stations of the virtual tracking area including the final small base station.

2. The paging management system of claim 1, wherein:
the small base station gateway configures, for each of the small base stations, the virtual tracking area by grouping a plurality of small base stations positioned within a predetermined distance from each corresponding small base station.

3. The paging management system of claim 2, wherein:
when the accessed small base station comprises a positioning equipment, the small base station gateway receives, from the accessed small base station, position information of the accessed small base station measured by the positioning equipment to verify a position of the accessed small base station.

4. The paging management system of claim 3, wherein:
the small base station gateway sets a circle having a radius of the predetermined distance based on the accessed small base station using the position information, and configures the virtual tracking area by grouping a plurality of small base stations positioned within the circle.

5. The paging management system of claim 2, wherein:
when the accessed small base station does not comprise a positioning equipment, the small base station gateway receives, from the accessed small base station, information associated with a neighboring small base station of the accessed small base station, and calculates a position of the accessed small base station based on a position of the neighboring small base station.

6. The paging management system of claim 5, wherein:
the small base station gateway groups a plurality of small base stations positioned within a predetermined number of hops from the accessed small base station, and thereby configures the virtual tracking area.

7. The paging management system of claim 2, wherein:
when a predetermined small base station is added or deleted, the small base station gateway reconfigures the virtual tracking area according to the added or deleted small base station.

8. The paging management system of claim 7, wherein:
the small base station gateway selects, as a representative base station, one of small base stations comprised in the virtual tracking area, and
when reconfiguring the virtual tracking area, the small base station gateway reconfigures the virtual tracking area based on the representative base station.

9. The paging management system of claim 1, wherein:
the small base station gateway transfers a list of the small base stations comprised in the virtual tracking area to each of the small base stations comprised in the virtual tracking area.

10. The paging management system of claim 9, wherein:
the accessed small base station broadcasts the list of the small base stations comprised in the virtual tracking area to terminals positioned within an area of the accessed small base station.

11. The paging management system of claim 10, wherein:
the terminal stores the broadcast list, and
when the terminal enters an area of a small base station excluded from the list, the terminal updates information associated with a new virtual tracking area.

12. The paging management system of claim 10, wherein:
the small base station gateway transfers the paging message to small base stations accessible by the terminal among the plurality of small base station of the virtual tracking area comprising the final small base station.

13. A paging management method, comprising:
configuring a virtual tracking area by grouping a plurality of small base stations according to a position of a small base station accessed by a terminal;
verifying a final small base station accessed by the terminal when a paging message is to be transmitted to the terminal; and
transferring the paging message to small base stations of the virtual tracking area including the final small base station.

14. The method of claim 13, wherein the configuring comprises configuring, for each of the small base stations, the virtual tracking area by grouping a plurality of small base stations positioned within a predetermined distance from each corresponding small base station.

15. The method of claim 14, wherein the configuring comprises:
receiving, from the accessed small base station, position information of the accessed small base station measured by a positioning equipment to verify a position of the accessed small base station when the accessed small base station comprises the positioning equipment;
setting a circle having a radius of the predetermined distance based on the accessed small base station using the position information; and
configuring the virtual tracking area by grouping a plurality of small base stations positioned within the circle.

16. The method of claim 14, wherein the configuring comprises:
receiving, from the accessed small base station, information associated with a neighboring small base station of the accessed small base station when the accessed small base station does not comprise a positioning equipment;
calculating a position of the accessed small base station based on a position of the neighboring small base station; and
configuring the virtual tracking area by grouping a plurality of small base stations positioned within a predetermined number of hops from the accessed small base station.

17. The method of claim 14, further comprising:
reconfiguring the virtual tracking area according to an added or deleted small base station when a predetermined small base station is added or deleted.

18. The method of claim 17, wherein the reconfiguring comprises:
selecting, as a representative base station, one of small base stations comprised in the virtual tracking area; and
reconfiguring the virtual tracking area based on the representative base station.

19. The method of claim 13, further comprising:
transferring a list of the small base stations comprised in the virtual tracking area to each of the small base stations comprised in the virtual tracking area.

20. The method of claim 13, wherein the transferring comprises transferring the paging message to small base stations accessible by the terminal among the plurality of small base station of the virtual tracking area comprising the final small base station.
